(19) United States
(12) Patent Application Publication
(10) Pub. No.: US 2002/0057293 A1
(43) Pub. Date: May 16, 2002

(54) Method of taking notes from an article displayed in an electronic book

(75) Inventor: Dih Lung Liao, Taipei (TW)

Correspondence Address: BACON & THOMAS, 4th Floor, 625 Slaters Lane, Alexandria, VA, 22314, US

(73) Assignee: FUTURE DISPLAY SYSTEMS INC., Taipei (TW)

(21) Appl. No.: 09/768,341

(22) Filed: Jan. 25, 2001

(30) Foreign Application Priority Data
Nov. 10, 2000 (TW) 89123897

(51) Int. Cl. G06F 3/00

(52) U.S. Cl. 345/781

(57) ABSTRACT

The present invention provides a method of taking notes in reading an article displayed in an electronic book. Said method comprises: (a) highlighting a character string of an article displayed on a display of an electronic book; (b) opening a note window on the display; (c) writing on a panel of the display or speaking to the electronic book, so that the written or spoken text is displayed in the note window by recognizing the input text with a computer program stored in said electronic book, and thus a note is made; and (d) recording said marked character string and said note in a functional relationship in a nonvolatile memory of said electronic book.

### FIELD OF THE INVENTION

The present invention relates to a method of reading and taking notes with an electronic book.

### BACKGROUND OF THE INVENTION

A reader or student needs to carry many books in order to satisfy his/her long and versatile desire in reading and studying. However, the weight of books becomes a burden for a reader or student in transport, particularly during travelling. Therefore, electronic books are used to replace conventional books, e.g. U.S. Pat. Nos. 5,739,814; 5,761,485; 5,761,681; and 5,802,516, etc. However, these known electronic books do not provide functions that enable a reader or student to record notes while reading. As a result, the user still needs to take notes by writing on a piece of paper or recording on a tape recorder which is rather cumbersome.

### SUMMARY OF THE INVENTION

The primary objective of the present invention is to provide an electronic book that has features enabling a reader to take notes conveniently while reading the book.

Another objective of the present invention is to provide a method of conveniently viewing and modifying notes while reading an article in the electronic book.

In order to accomplish these objectives, a method of taking notes from an article displayed on an electronic book according to the present invention comprises the following steps, wherein said electronic book is a pointer-based computer comprising a CPU; a nonvolatile memory connected to said CPU; a display connected to said CPU, which has a touch-sensitive panel; and a touch pen:

a) highlighting a character string in an article displayed on said display through an interaction between said touch pen and said panel;

b) opening a note window on said display;

c) writing a text on said panel with said touch pen, and recognizing the written text with said computer, so that the written text is displayed in the note window, and thus a note is made; and

d) recording said highlighted character string and said note in a functional relationship in said nonvolatile memory.

Preferably, the method of the present invention further comprises:

e) closing said note window.

Preferably, said functional relationship in step d) is an one-to-one relationship.

Preferably, said steps b) to d) are repeated to take a plurality of notes on said highlighted note, wherein said functional relationship is an one-to-plural relationship between said highlighted character string and said plural notes. Preferably, said plurality of notes are taken at different times and said times are correspondingly recorded in said nonvolatile memory, so that said plurality of notes can be distinguished according to time. Preferably, authors of said plurality of notes are correspondingly recorded in said nonvolatile memory, such that said plurality of notes can be distinguished according to author. More preferably, said plurality of notes are taken at different times and said times are correspondingly recorded in said nonvolatile memory, so that said plurality of notes can be distinguished according to time and author.

Preferably, said steps b) to d) are repeated to edit and update said note.

Preferably, said article in step a) is displayed on said display page-by-page.

Preferably, said highlighted character string of step a) is given a bookmark, and said bookmark is recorded in said nonvolatile memory in step d).

Preferably, said functional relationship is based on said bookmark.

Preferably, said electronic book further comprises an audio input device, wherein said method further comprises using said audio input device to receive a speech, and recognizing text of said speech with said computer in making said note in step c).

### BRIEF DESCRIPTION OF THE DRAWINGS

FIG. 1 shows a structural block diagram of an electronic book applicable to a method according to the present invention;

FIG. 2 shows a flowchart of the method according to the present invention;

FIG. 3 shows a flowchart of the sub-steps of step 1 in FIG. 2.

### DETAILED DESCRIPTION OF THE PREFERRED EMBODIMENTS

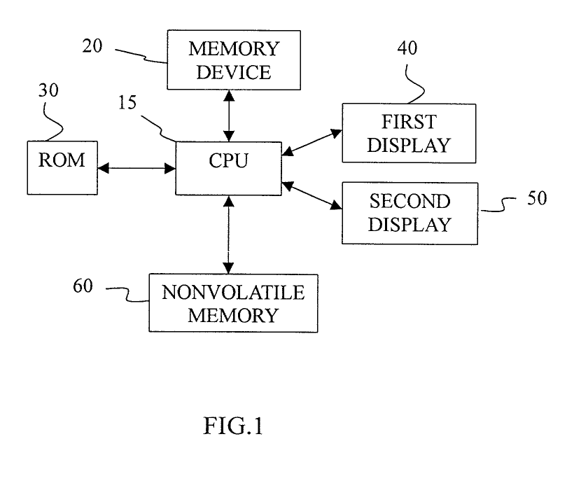

A personal electronic book for replacing a conventional book is shown in FIG. 1, which is a pointer-based computer comprising a CPU 15; a memory device 20 (e.g. a PCMCI card or a C.F. card) connected to said CPU for storing articles; a ROM 30 connected to said CPU for storing programs; a first display 40 and a second display 50 connected to said CPU; and a read/write nonvolatile memory 60 (e.g. a mini-harddisk or a SDRAM) connected to said CPU for storing personal data and notes. Said first display 40 and said second display 50 are a flat panel display, such as LCD, and at least one of them has a touch sensitive panel.

While in use, said CPU 15 executes a program stored in said ROM 30 to display page-by-page an article stored in said memory device 20 on said first display 40 and said second display 50. A touch pen, not shown in the figure, contacts an icon displayed on said first display 40 or said second display 50, or a button provided on said electronic book, to achieve an effect similar to turning a page in a conventional book.

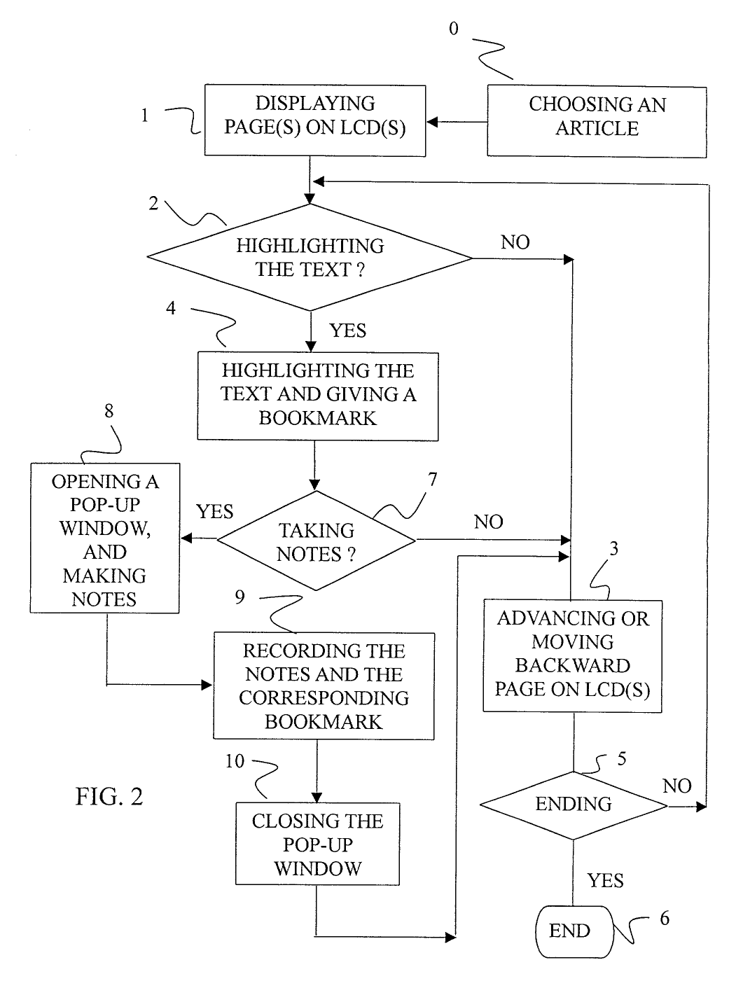

As shown in FIG. 2, after a user activates an electronic book shown in FIG. 1, steps 0 and 1 are executed to display the contents of two pages of the selected article displayed on said first display 40 and said second display 50. If the user does not intend to take a note on the contents of the two pages, a page-turning command can be executed to turn a page forward or backward and continue reading. If the user intends to take a note, he/she then uses said touch pen to highlight a character string and bookmark said string, as shown in steps 2, 3 and 4 in FIG. 2. The user reads the article by turning the page forward or backward in step 3 until he/she selects the ending option (steps 5 and 6) or returns to step 2 to take notes.

When a character string is highlighted, said electronic book will ask the user whether a note is to be taken (step 7). If the answer is NO, a bookmark is recorded in the nonvolatile memory 60, and said electronic book will proceed to step 3. Said bookmark will enable the user to return to said highlighted character string promptly. If the user intends to take a note, then said electronic book proceeds from step 7 to step 8 where a pop-up window is activated on said first display or said second display. The user uses said touch pen to write text on said first or second display, and the computer recognizes the text, and shows the text in the pop-up window. Upon completion of taking the note, said note and said bookmark are correspondingly recorded in said nonvolatile memory 60 (step 9) and said pop-up window is closed (step 10), and said electronic book proceeds to Step 3 for the user to continue in reading. The above-mentioned highlighted character string, bookmark and note are stored in a functional relationship. For example, said highlighted character string and said bookmark are in an one-to-one relationship; and said bookmark and said note are in a one-to-one relationship. Said bookmark and said note are in an one-to-one relationship when there is only one record of the note. However, when notes are taken at different times and/or by different users, the relationships between said bookmark and the notes are one to plural. The time of completion of and the author of a note are correspondingly stored in order to distinguish notes to the same bookmark by time and/or author.

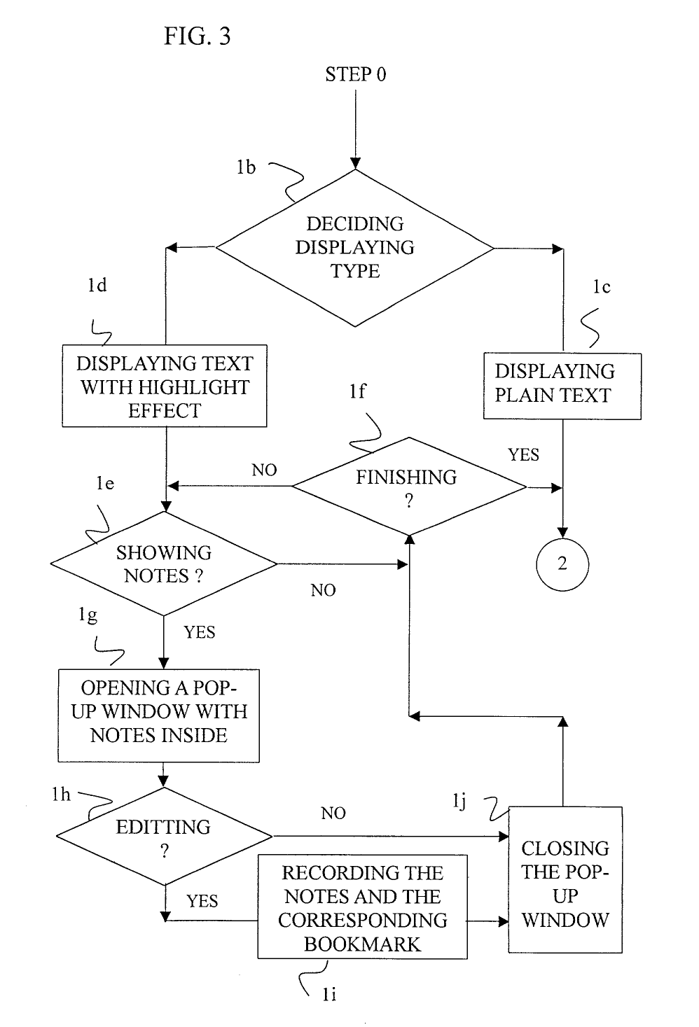

Step 1 in FIG. 2 includes sub-steps shown in FIG. 3, the first of which is a decision of the form of display (step 1b). If the highlight effect is decided not to be displayed, step 1c and then step 2 are carried out. If the highlight effect is decided to be displayed, step 1b and then Step 1d are carried out, where the contents of two pages of said article with the highlight effect are displayed on said first display 40 and said second display 50. If said user uses the touch pen to touch said highlighted character string, said electronic book will query the user whether he or she wants to display the note taken on said highlighted character string (step 1e). If the answer is NO, step if is carried out to determine whether the user want to finish reviewing all the notes on the highlighted text in the two pages. If the answer is YES, a pop-up window is activated to display said note (step 1g). At this time, said user can choose to edit or not to edit said note (step 1h). The bookmark of the highlighted character string and the edited note are correspondingly recorded in step 11, and next said pop-up window is closed in step 1j. If the option of not to edit the note in step 1h is chosen, said electronic book proceeds directly to step 1j and then to step 1f. At step if if the user determines to finish reviewing all the notes on the highlighted text in the two pages, the user can proceed with step 2; if not, the user can proceed with step 1g. Alternatively, steps 4, 7, 8, 9 and 10 in FIG. 2 can be carried out before step 1f in FIG. 3. That is, while reading the two pages, said user can alternately carry out the editing of the notes on the original highlighted strings or highlight a new character string and make a note on it.

Although the above-mentioned method uses the first display 40 and the second display 50 to display contents of two pages, it is obvious that the method of the present invention can be performed with an electronic book having only one display.

1. A method of taking notes from an article displayed on an electronic book, wherein said electronic book is a pointer-based computer comprising a CPU; a nonvolatile memory connected to said CPU; a display connected to said CPU, which has a touch-sensitive panel; and a touch pen; said method comprising the following steps:
a) highlighting a character string in an article displayed on said display through an interaction between said touch pen and said panel;
b) opening a note window on said display;
c) writing a text on said panel with said touch pen, and recognizing the written text with said computer, so that the written text is displayed in the note window, and thus a note is made; and
d) recording said highlighted character string and said note in a functional relationship in said nonvolatile memory.

2. The method as claimed in claim 1 further comprising e) closing said note window.

3. The method as claimed in claim 1, wherein said functional relationship is an one-to-one relationship.

4. The method as claimed in claim 1, wherein steps b) to d) are repeated to take a plurality of notes on said highlighted note, wherein said functional relationship is an one-to-plural relationship between said highlighted character string and said plural notes.

5. The method as claimed in claim 4, wherein said plurality of notes are taken at different times and said times are correspondingly recorded in said nonvolatile memory, so that said plurality of notes can be distinguished according to time.

6. The method as claimed in claim 4, wherein authors of said plurality of notes are correspondingly recorded in said nonvolatile memory, such that said plurality of notes can be distinguished according to author.

7. The method as claimed in claim 6, wherein said plurality of notes are taken at different times and said times are correspondingly recorded in said nonvolatile memory, so that said plurality of notes can be distinguished according to time and author.

8. The method as claimed in claim 3, wherein steps b) to d) are repeated to edit and update said note.

9. The method as claimed in claim 1, wherein said article in step a) is displayed on said display page-by-page.

10. The method as claimed in claim 1, wherein said highlighted character string of step a) is given a bookmark, and said bookmark is recorded in said nonvolatile memory in step d).

11. The method as claimed in claim 10, wherein said functional relationship is based on said bookmark.

12. The method as claimed in claim 1, wherein said electronic book further comprises an audio input device, wherein said method further comprises using said audio input device to receive a speech, and recognizing text of said speech with said computer in making said note in step c).
